(19) United States
(12) Patent Application Publication
(10) Pub. No.: US 2017/0299545 A1
(43) Pub. Date: Oct. 19, 2017

(54) SENSOR PACKAGE HAVING AN ELECTRICAL CONTACT

(71) Applicant: TYCO ELECTRONICS CORPORATION, Berwyn, PA (US)

(72) Inventor: Matthew Edward Mostoller, Hummelstown, PA (US)

(21) Appl. No.: 15/132,722

(22) Filed: Apr. 19, 2016

(51) Int. Cl. G01N 27/416; G01N 27/407; G01N 27/417

(52) U.S. Cl. CPC G01N 27/4166; G01N 27/417; G01N 27/4071; G01N 27/4078

(57) ABSTRACT

Sensor package is provided that includes a package housing defining a receiving cavity and having a package side. The package side includes a detector opening therethrough. The sensor package also includes a sensor module held by the package housing and disposed within the receiving cavity. The sensor module has a sensor side that is aligned with the detector opening such that the sensor side is exposed to a detection space. The sensor module also includes a conductive pathway that is configured to transmit signals that are based on an environmental parameter detected by the sensor module. The sensor package also includes an electrical contact that is coupled to the package housing. The electrical contact includes a contact finger. The contact finger is engaged to the conductive pathway and exerts a normal force against the conductive pathway.

### BACKGROUND

The subject matter herein relates generally to sensors that detect one or more qualities of an ambient environment, such as the detection of designated gases.

A variety of sensors exist today that may be used to detect one or more qualities of an ambient environment. Known sensors may be used to detect a temperature, one or more gases, vibrations or shock, and the like. Carbon monoxide (CO) and carbon dioxide (CO₂) sensors may use electrochemical technology to detect levels of the respective gases in the surrounding environment. Electrochemical technology may be particularly suitable, because it may be more accurate and selective at low levels of the gas-of-interest and may require only a small amount of power. The electrochemical technology typically creates current or voltage changes and thereby generate signals that correspond to an amount of the gas-of-interest in the ambient environment. These signals are conveyed along conductive paths to logic-based circuitry (e.g., processor or hardwired circuitry) that analyzes the signals to determine whether the amount of gas has exceeded a threshold.

The above sensors, however, are not without drawbacks. For instance, the electrochemical technology may be damaged if exposed to high temperatures when, for example, assembling packages or units that include the sensors. Accordingly, sensor packages that utilize electrochemical technology (or are otherwise susceptible to damage from heat) are typically constructed without soldering or welding conductive elements to one another. For example, conductive elements may be coupled to one another through conductive epoxies. In addition to the challenges created by high temperature processes, the sensor packages may include additional components (e.g., circuit boards) that form conductive pathways for conveying the signals away from the sensor. Using conductive epoxies or other intervening components, however, can complicate the manufacturing process and/or require expensive materials. As such, the cost of the sensors and/or sensor packages can be expensive.

Accordingly, there is a need for a sensor package that may be manufactured in a less costly manner than known sensor packages.

### BRIEF DESCRIPTION

In an embodiment, a sensor package is provided that includes a package housing defining a receiving cavity and having a package side. The package side includes a detector opening therethrough. The sensor package also includes a sensor module held by the package housing and disposed within the receiving cavity. The sensor module has a sensor side that is aligned with the detector opening such that the sensor side is exposed to a detection space. The sensor module also includes a conductive pathway that is configured to transmit signals that are based on an environmental parameter detected by the sensor module. The sensor package also includes an electrical contact that is coupled to the package housing. The electrical contact includes a contact finger. The contact finger is engaged to the conductive pathway and exerts a normal force against the conductive pathway.

In one or more aspects, the package housing includes a socket housing and a retaining cover. The sensor module may be positioned between the socket housing and the retaining cover. Optionally, the socket housing may form a seating space that is sized and shaped to receive the sensor module. The contact finger is positioned within or adjacent to the seating space. The retaining cover holds the sensor module at a designated position as the contact finger presses against the conductive pathway of the sensor module.

In one or more aspects, the retaining cover includes a latch. The latch may grip the socket housing. The retaining cover may hold the sensor module at a designated position as the contact finger presses against the conductive pathway of the sensor module.

In one or more aspects, the electrical contact includes a mating terminal that is configured to mechanically and electrically engage another conductive element. Optionally, the mating terminal includes a compliant pin that is sized and shaped to be inserted into a corresponding hole of a conductive element. Optionally, the sensor package also includes a plug assembly having a modular plug and a cable that includes a coupling end. The coupling end is mechanically and electrically engaged to the mating terminal of the electrical contact. The cable electrically connects the modular plug and the electrical contact.

In an embodiment, a sensor package is provided that includes a package housing defining a receiving cavity and having a package side. The package side includes a detector opening therethrough. The sensor package also includes a sensor module that is held by the package housing and disposed within the receiving cavity. The sensor module has a sensor side that is aligned with the detector opening such that the sensor side is exposed to a detection space. The sensor module also includes a conductive pathway that is configured to transmit signals that are based on an environmental parameter detected by the sensor module. The sensor package also includes an electrical contact that is coupled to the package housing. The electrical contact is electrically coupled to the conductive pathway of the sensor module. The electrical contact includes a mating terminal that is configured to mechanically and electrically engage another conductive element.

In an embodiment, a detection device is provided. The detection device includes a circuit board and a sensor package is mounted to the circuit board. The sensor package includes a package housing defining a receiving cavity and having a package side. The package side includes a detector opening therethrough. The sensor package also includes a sensor module held by the package housing and disposed within the receiving cavity. The sensor module has a sensor side that is aligned with the detector opening such that the sensor side is exposed to a detection space. The sensor module also includes a conductive pathway that is configured to transmit signals that are based on an environmental parameter detected by the sensor module. The sensor package also includes an electrical contact that is coupled to the package housing. The electrical contact includes a contact finger. The contact finger is engaged to the conductive pathway and exerts a normal force against the conductive pathway. The electrical contact is electrically connected to the circuit board.

### BRIEF DESCRIPTION OF THE DRAWINGS

FIG. 1 is a top perspective view of a sensor package formed in accordance with an embodiment.

FIG. 2 is a bottom perspective view of a sensor package formed in accordance with an embodiment.

FIG. 3 is an isolated bottom perspective view of a retaining cover that may be utilized by the sensor package of FIG. 1.

FIG. 4 is an isolated top perspective view of a socket housing that may be utilized by the sensor package of FIG. 1.

FIG. 5 is an isolated bottom perspective view of the socket housing that may be utilized by the sensor package of FIG. 1.

FIG. 6 is a bottom plan view of the socket housing that may be utilized by the sensor package of FIG. 1.

FIG. 7 is an isolated perspective view of an electrical contact that may be utilized by the sensor package of FIG. 1.

FIG. 8 is an isolated perspective view of an electrical contact that may be utilized by a sensor package formed in accordance with an embodiment.

FIG. 9 is an isolated perspective view of a package base that includes the socket housing and a plurality of the electrical contacts of FIG. 7.

FIG. 10 is an exploded view of the sensor package of FIG. 1 illustrating how the elements may be stacked with respect to one another.

FIG. 11 is an enlarged cross-section of a portion of the sensor package of FIG. 1.

FIG. 12 is an isolated perspective view of a sensor package formed in accordance with an embodiment.

### DETAILED DESCRIPTION

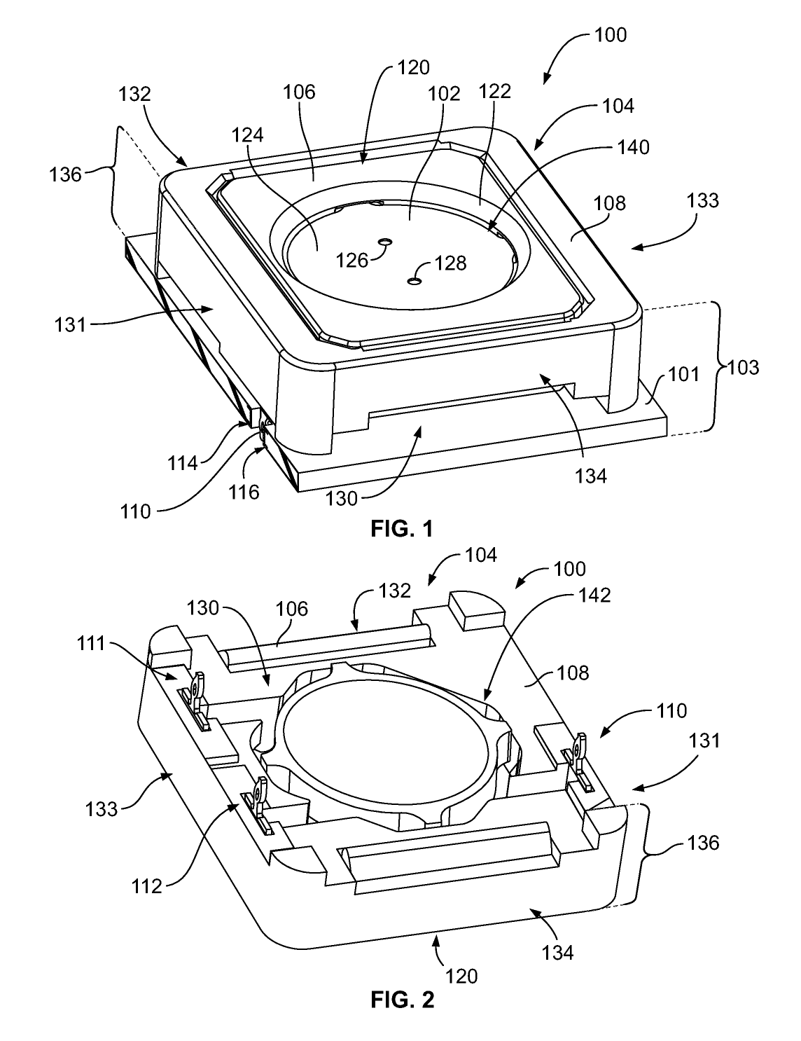

FIG. 1 is a top perspective view of a sensor package 100 formed in accordance with an embodiment, and FIG. 2 is a bottom perspective view of the sensor package 100. The sensor package 100 includes a sensor module (or sensor) 102 and a package housing 104 that holds the sensor module 102. In FIG. 1, the sensor package 100 is mounted to a circuit board 101. The circuit board 101 may be coupled to other components, such as other circuitry. Collectively, the sensor package 100 and the circuit board 101 may form a circuit board assembly 103 (or sub-assembly 103). The circuit board assembly 103 may form a portion of a larger device (e.g., detection device) or may constitute the detection device. In other embodiments, however, the sensor package 100 is not mounted to the circuit board 101. Instead, the sensor package 100 may be communicatively coupled with other components through, for example, insulated wires.

The sensor package 100 (or the circuit board assembly 103) is configured to be positioned at a designated location for detecting one or more qualities of the surrounding environment. These qualities may be referred to a environmental parameters. For example, in the illustrated embodiment, the sensor module 102 is configured to monitor (e.g., by periodically or continuously detecting) the surrounding environment for one or more gases. In particular embodiments, the sensor module 102 utilizes electrochemical technology for detecting one or more qualities of the surrounding environment. Non-limiting examples of such gases may include carbon monoxide (CO), carbon dioxide (CO₂), hydrogen sulfide (H₂S), ethanol, ozone (O₃), nitrogen dioxide (NO₂), sulfur dioxide (SO₂), and/or related compounds that can be either electro-oxidized or electro-reduced compounds. Breath alcohol may also be detected or monitored by one or more embodiments. In particular embodiments, the sensor module 102 is an electrochemical sensor that is configured to detect one or more gases (e.g., CO and/or CO₂).

In some embodiments, the sensor module 102 may be a printed sensor or, more specifically, a printed gas sensor in which one or more components (e.g., electrodes, substrates) are printed through screen-printing, ink-printing, or similar printing process. The sensor module 102 may form a single structural unit having a plurality of discrete parts coupled to one another. The sensor module 102 may include, for example, a substrate that is at least partially gas porous or gas permeable, an electrode layer, and an electrolyte layer that is in electrolytic contact with the electrode layer. The electrode layer may include, for example, two or more electrodes, with one at least partially porous electrode. The electrodes may be formed on one side of the porous substrate. The electrolyte layer may include at least one of a solid, liquid, gel, or similarly functional material. An optional encapsulation layer may encapsulate the electrode layer and part or all of its substrate and electrolyte layer. Examples of electrolyte material include aqueous or hydrophilic room temperature ionic liquid or a hydrophobic organic electrolyte. One particular example is H₂SO₄, but it should be understood that a variety of electrolytes exist that may be suitable for embodiments set forth herein. The sensor module 102 may also include a reservoir that can function as an overflow chamber that receives expanding electrolyte or other material of the sensor module 102. The reservoir may be positioned along an opposite side of the sensor module 102 from the access ports of the sensor module 102.

During operation of the sensor module, a target gas, the electrolyte, and the electrode may generate an electric current through an electrochemical reaction. The electric current may represent or form an electric signal that is transmitted to one or more circuits that are formed by or connected to conductive pathways of the sensor modules. These conductive pathways are electrically coupled to the electrical contacts set forth herein.

It should be understood, however, that the sensor package 100 may hold a one or more other types of sensors for detecting other gases or other qualities (e.g., temperature, vibrations, and the like) in the surrounding environment.

The package housing 104 includes a retaining cover 106 and a socket housing 108. In the illustrated embodiment, the retaining cover 106 and the socket housing 108 are discrete with respect to one another, but are configured to be coupled to one another when the sensor package 100 is fully assembled. The retaining cover 106 and the socket housing 108 may be, for example, molded in separate cavities for the illustrated embodiment. The retaining cover 106 and the socket housing 108 may comprise, for at least some portions, a dielectric material. In other embodiments, however, the features of the retaining cover 106 and the socket housing 108 may be combined into a single unitary element. For example, the retaining cover 106 and the socket housing 108 may be molded within a single cavity such that the package housing 104 is a single unitary element.

The sensor package 100 also includes one or more electrical contacts. In the illustrated embodiment, the sensor package 100 includes an electrical contact 110, an electrical contact 111 (FIG. 2), and an electrical contact 112 (FIG. 2). It should be understood, however, that the sensor package 100 may include more or fewer electrical contacts. For example, the sensor package 100 may include only one electrical contact, only two electrical contacts, four electrical contacts, or more. In the illustrated embodiment, the electrical contacts 110-112 include mating terminals 114 that are configured to mechanically and electrically engage another component. For example, the mating terminals 114 are compliant pins in FIGS. 1 and 2 that are configured to be inserted into and engage respective plated thru-holes 116 (FIG. 1) of the circuit board 103.

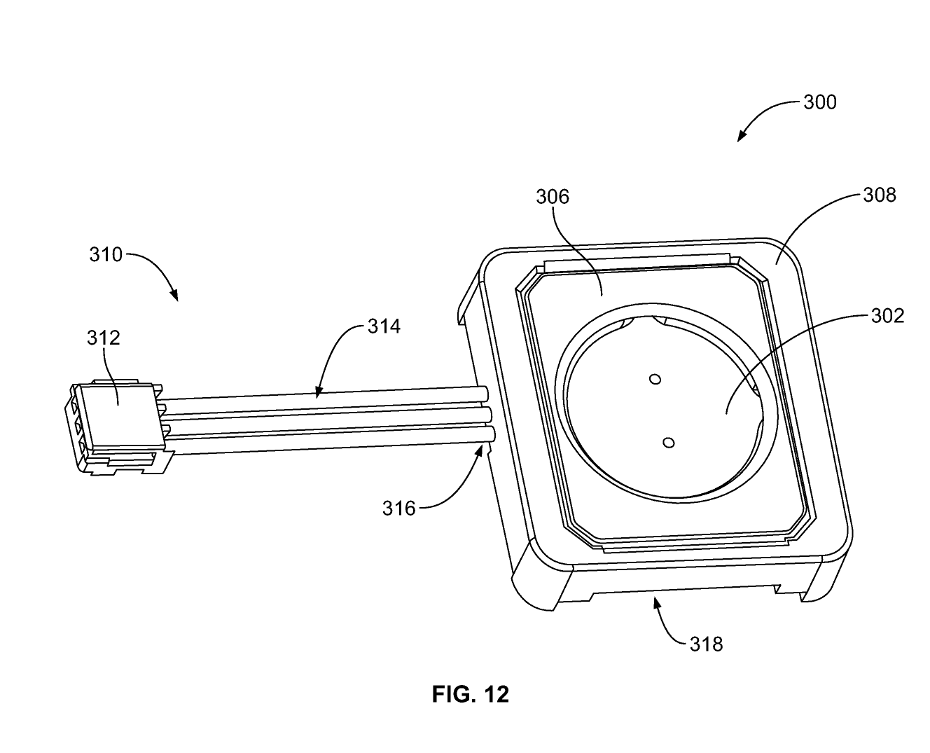

In other embodiments, however, one or more of the electrical contacts 110-112 may not couple to the circuit board 101. For example, the electrical contacts 110-112 may include terminals (not shown) that are configured to electrically couple to insulated wires (not shown) that electrically connect the electrical contacts 110-112 to, for example, a modular plug. Such an embodiment is described with reference to FIG. 12.

The sensor package 100 (or the package housing 104) includes a package side 120 (hereinafter referred to as a first package side 120) that is formed, at least in part, by the retaining cover 106. The first package side 120 includes a detector opening 122 therethrough. More specifically, the retaining cover 106 includes the detector opening 122, which exposes a sensor side 124 of the sensor module 102. The sensor side 124 is aligned with the detector opening 122 such that the sensor side 124 is exposed to a detection space 140. The detector opening 122 permits access ports 126, 128 to be in flow communication with the surrounding environment. In other embodiments, the access ports 126, 128 may have a different location and, as such, the detector opening 122 of the package housing 104 may have a different location so that the access ports 126, 128 may be in flow communication with the surrounding environment.

The detection space 140 extends alongside the sensor module 102 at the sensor side 124. The detection space 140 represents the volume of space that is immediately adjacent to the sensor module 102 and is in flow communication with the access ports 126, 128. More specifically, the detection space 140 is configured to permit air flow (or gas flow) proximate to the access ports 126, 128 so that gases may flow through (e.g., into or out of) one or both of the access ports 126, 128. The detection space 140 is defined, at least in part, by the retaining cover 106. In other embodiments, the retaining cover 106 may have different shapes to change a shape of the detection space 140. For example, the retaining cover 106 may be shaped to form a venturi that directs a flow of gas alongside the sensor side 124.

The sensor package 100 also includes a package side 130 (hereinafter referred to as a second package side 130) that is opposite the first package side 120. In the illustrated embodiment, the second package side 130 is configured to be mounted to the circuit board 101. For clarity, the first package side 120 may be referred to as the detection side, and the second package side 130 may be referred to as the mounting side 130. The sensor package 110 (or the package housing 104) also includes side walls 131-134. The side walls 131-134 extend between the first package side 120 and the second package side 130.

As shown, the sensor package 100 has a height 136 that is measured between the first and second package sides 120, 130. In some embodiments, the sensor package 100 is a low-profile package having a height that is less than 20 millimeters (mm) or, more particularly, less than 15 mm. In certain embodiments, the height 136 may be less than 10 mm or, more particularly, less than 8 mm. In other embodiments, however, the sensor package 100 is not required to be a low-profile sensor package.

As shown in FIG. 2, the package housing 104 defines a receiving cavity 142. In the illustrated embodiment, the receiving cavity 142 is formed when an opening to a socket cavity 169 (shown in FIG. 4) is covered by the retaining cover 106. For embodiments in which the package housing 104 is a single component that includes the features of the retaining cover and the socket housing, however, the receiving cavity 142 may be formed after the package housing 104 is formed (e.g., molded). The sensor module 102 is sized and shaped to be disposed within the receiving cavity 142. FIG. 2 shows a sensor side 125 of the sensor module 102 that is opposite the sensor side 124 (FIG. 1). The sensor side 125 may be adjacent to a reservoir (not shown) of the sensor module 102.

Although not required, the sensor packages set forth herein may have a relatively small size (e.g., 40×40×20 mm or smaller), may have a relatively long life (e.g., life expectancy of 5 years, 10 years, or more), and/or may be capable of being individually calibrated. Embodiments may also be Restriction of Hazardous Substances (RoHS) compliant and may be designed to conform to one or more standards, such as UL STD 2034 and/or UL STD 2075. Embodiments may be integrated with wireless, portable, and/or networked solutions.

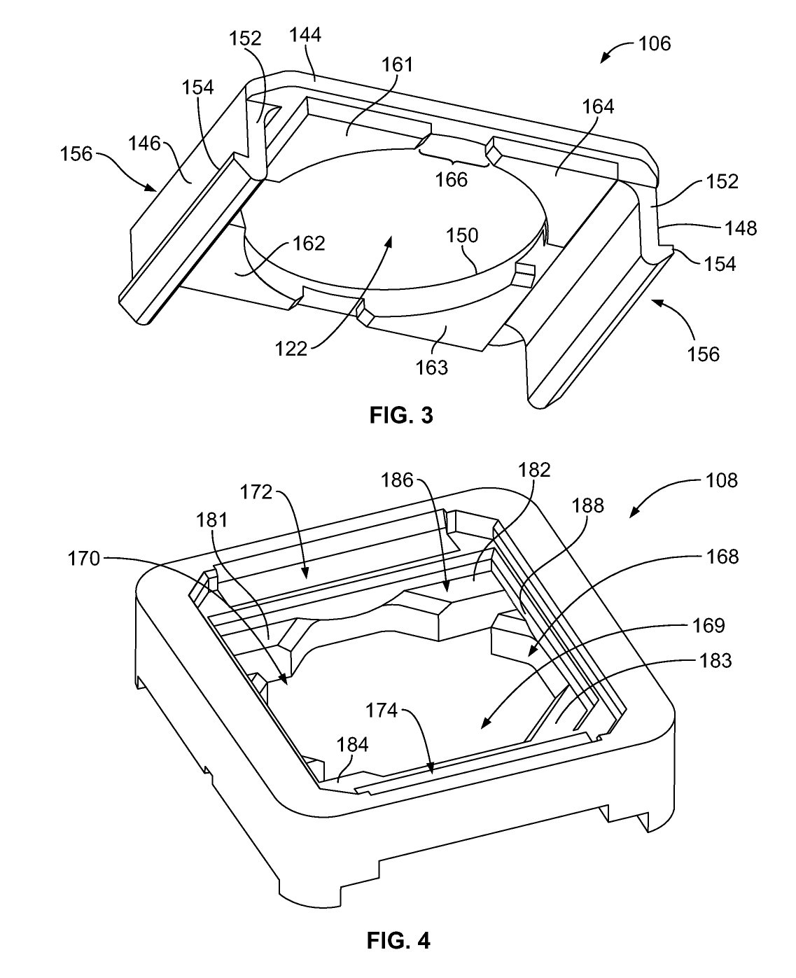

FIG. 3 is an isolated bottom perspective view of the retaining cover 106. The retaining cover 106 includes a cover section 144 and attachment structures 146, 148 that are coupled to the cover section 144. The cover section 144 extends between the attachment structures 146, 148 and represent the portion of the retaining cover 106 that covers the sensor side 124 (FIG. 1) and defines at least a portion of the first package side 120 (FIG. 1).

The cover section 144 includes the detector opening 122. The detector opening 122 is defined by a cover edge 150 of the cover section 144. The cover edge 150 may be sized and shaped to provide a desired detection space 140 (FIG. 1) alongside the sensor side 124 (FIG. 1). For example, in the illustrated embodiment, the cover edge 150 is substantially circular thereby defining a short, cylindrical detection space 140. In other embodiments, however, the cover edge 150 may have a different geometric shape.

Also shown, the cover section 144 is essentially two-dimensional such that the cover section 144 has an essentially planar body. In other embodiments, however, the cover section 144 may have a three-dimensional shape to provide a different detection space. For example, the cover section 144 may be shaped to form a venturi for directing air flow in a predetermined manner across the sensor side 124. For embodiments in which the retaining cover 106 is separate and discrete with respect to the socket housing 108, it may be possible to use a different retaining cover or to replace the retaining cover for a retaining cover that provides a desired detection space. As such, the same package housing 104 and sensor module 102 may be used, but a different retaining cover may be used to provide sensor packages 100 that are tailored or configured for desired applications.

The attachment structures 146, 148 include respective cover walls 152 and grips 154. In the illustrated embodiment, each cover wall 152 and respective grip 154 defines a corresponding latch 156. The latches 156 are configured to engage the socket housing 108 to hold the sensor module 102 (FIG. 1) at a designated position. Although FIG. 3 illustrates one design of the attachment structures 146, 148, it should be understood that the attachment structures 146, 148 may have other shapes. In other embodiments, the socket housing 108 includes latches that grip the retaining cover 106. For example, the retaining cover 106 may essentially be the cover section 144 without the attachment structures 146, 148 in other embodiments.

The retaining cover 106 may include one or more internal bosses. For example, the retaining cover 106 includes a plurality of internal bosses 161-164. The internal bosses 161-164 are configured to directly interface with the sensor module 102 (FIG. 1) and/or the socket housing 108 (FIG. 1). The internal bosses 161-164 may be shaped to complement a seating space 170 (shown in FIG. 4) of the socket housing 108. In the illustrated embodiment, adjacent internal bosses 161-164 define slots 166 therebetween. The slots 166 are sized and shaped to receive respective portions of the sensor module 102.

FIG. 4 is an isolated top perspective view of the socket housing 108. The socket housing 108 has a receiving side 168 that permits access to a socket cavity 169. The socket cavity 169 is sized and shaped to receive the sensor module 102 (FIG. 1). In the illustrated embodiment, the socket cavity 169 extends entirely through the socket housing 108. In other embodiments, the socket cavity 169 may not extend entirely through the socket housing 108. Instead, the socket cavity 169 may extend a depth into the socket housing 108 that is sufficient for receiving the sensor module 102. The depth may also be sufficient for allowing airflow along a bottom side of the sensor module 102. The socket housing 108 also includes receiving slots 172, 174 that are sized and shaped to receive the attachment structures 146, 148, respectively.

The socket housing 108 defines a seating space 170 that is configured to receive the sensor module 102 (FIG. 1). The seating space 170 is defined by internal surfaces of the socket housing 108 that interface with the sensor module 102. As used herein, the phrase “interfaces with” includes at least one of directly engaging or facing each other with a nominal distance therebetween. For example, the socket housing 108 includes shoulders 181-184 having respective seating surfaces 186 that face the sensor module 102. The socket housing 108 may also include an edge surface 188 that extends around a perimeter of the sensor module 102.

At least portions of the sensor module 102 (FIG. 1) are configured to be positioned between the retaining cover 106 (FIG. 1) and the socket housing 108. In the illustrated embodiment, portions of the sensor module 102 are positioned between the shoulders 181-184 and the bosses 161-164 (FIG. 3), respectively. Although the FIGS. 3 and 4 illustrate one configuration of the retaining cover 106 and the socket housing 108, it should be understood that a variety of configurations may be used that would enable holding the sensor module 102 therebetween.

In an alternative embodiment, the retaining cover 106 and the socket housing 108 may be a common unitary element. For example, one of the attachment structures 146, 158 may be replaced by a hinge (not shown) that is integrally formed with the socket housing 108. The other attachment structure may be configured to engage the socket housing 108 in a similar manner as shown in the illustrated embodiment. Yet in another alternative embodiment, the retaining cover 106 and the socket housing 108 may not be movable with respect to each other. Instead, the package housing 104 may have an opening along the second package side 130 (FIG. 1) that is sized and shaped to receive the sensor module 102. In such embodiments, the sensor module 102 may form an interference fit with elements of the socket housing 108.

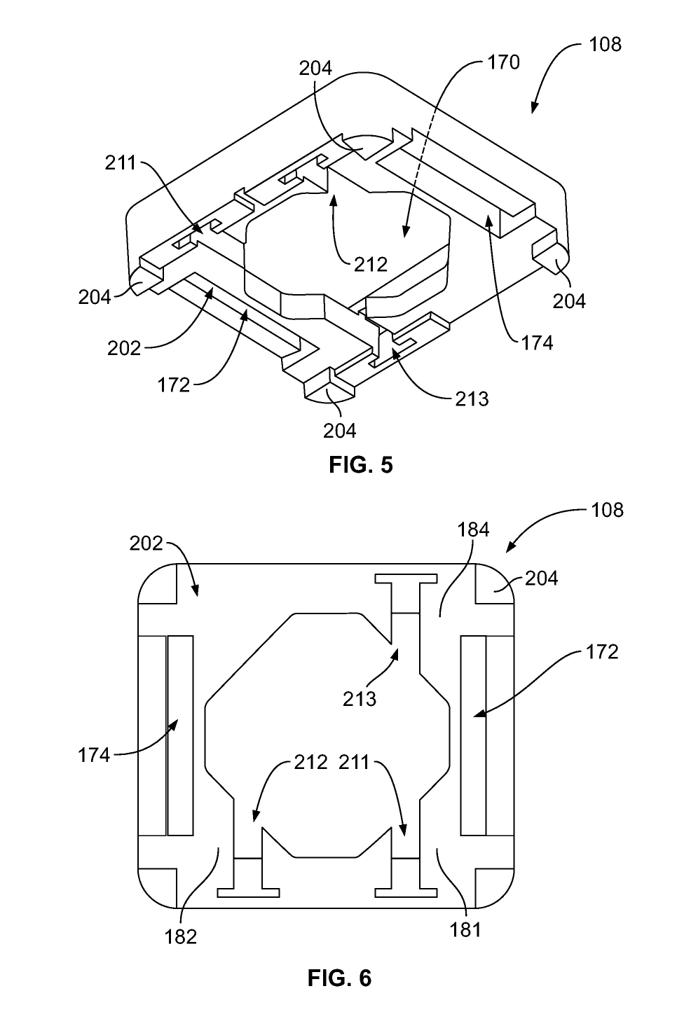

FIG. 5 is an isolated bottom perspective view of the socket housing 108, and FIG. 6 is a bottom plan view of the socket housing 108. As shown, the receiving slots 172, 174 extend entirely through the socket housing 108. In other embodiments, the receiving slots 172, 174 extend only partially through the socket housing 108. The socket housing 108 has an underside 202 that is configured to be mounted to another component, such as the circuit board 101 (FIG. 1). In other embodiments, such as the embodiment of FIG. 12, the underside 202 may be mounted to another component. As shown, the underside 202 is shaped to include posts or stands 204. The posts 204 are configured to provide a gap between the underside 202 and the other component.

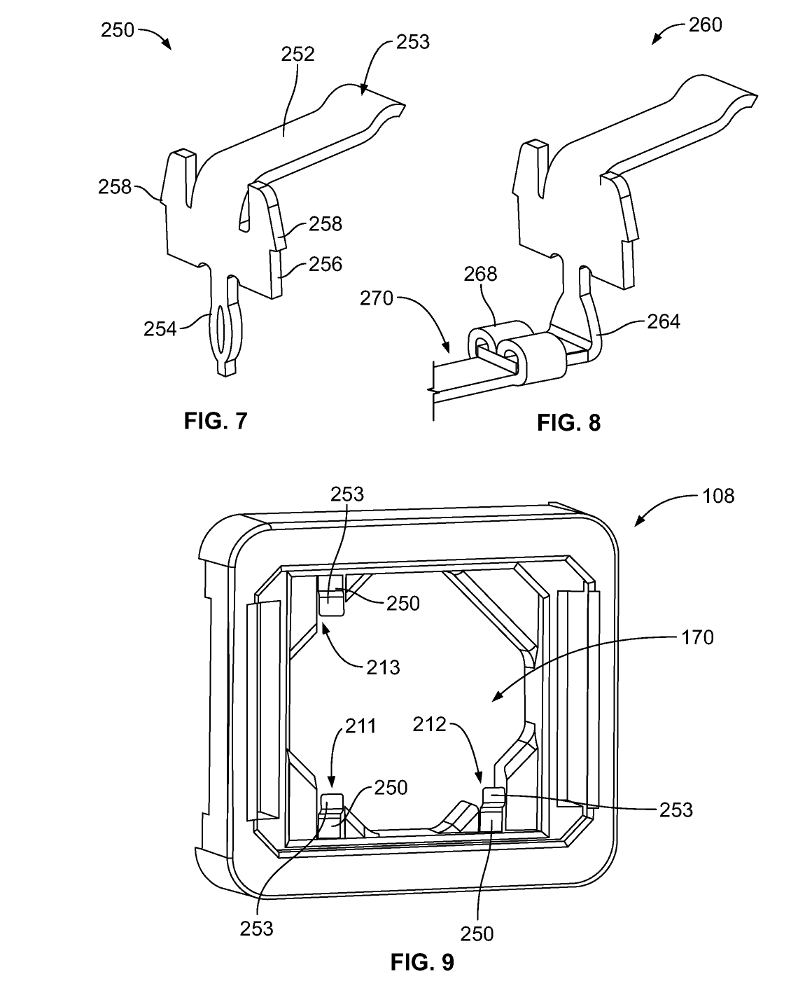

Also shown, the socket housing 108 includes a plurality of contact channels 211-213. The contact channels 211-213 extend from the underside 202 to the seating space 170 (FIG. 5, also shown in FIG. 4). In the illustrated embodiment, the contact channels 211-213 extend through the shoulders 181, 182, and 184, respectively. The contact channels 211-213 are sized and shaped relative to the electrical contacts 250 (shown in FIG. 7) or electrical contacts 260 (shown in FIG. 8). As shown, the contact channels 211-213 are open-sided channels that open to the socket cavity 169. In other embodiments, however, the contact channels 211-213 may not be open-sided. The contact channels 211-213 are defined by interior surfaces of the socket housing 108 that are configured to frictionally engage the electrical contacts 250 (or the electrical contacts 260).

FIG. 7 is an isolated perspective view of the electrical contact 250. The electrical contact 250 is identical to the electrical contacts 110-112. The electrical contact 250 is configured to be utilized by the sensor package 100 (FIG. 1). The electrical contact 250 is configured to engage the package housing 104 (FIG. 1). In particular embodiments, the electrical contact 250 is configured to engage the socket housing 108 (FIG. 1) such that the electrical contact 250 has a fixed position relative to the socket housing 108. In the illustrated embodiment, the electrical contact 250 includes a contact finger 252, a mating terminal 254, and a body section 256 that extends between and couples the contact finger 252 and the mating terminal 254.

The body section 256 is configured to frictionally engage the interior surfaces of the socket housing 108 such that the electrical contact 250 may be held in a substantially fixed position during operation. As such, the body section 256 is shaped relative to the corresponding contact channel that receives the electrical contact 250. For example, the body section 256 may include one or more projections 258 that are shaped to grip the socket housing 108 (FIG. 1). As shown, the projections 258 are barb-shaped such that the body section 256 is permitted to be inserted into the corresponding contact channel through the underside 202, but may engage and impede removal of the electrical contact 250.

The contact finger 252 includes a mating interface 253 that is configured to directly engage conductive pathways 280 (shown in FIG. 11) of the sensor module 102. The conductive pathways 280 are configured to transmit signals (e.g., current) based on an environmental parameter detected by the sensor module 102. For example, the amount of current transmitted by the conductive pathways 280 may be based on an amount of target gas that is detected by the sensor module 102. In the illustrated embodiment, the contact finger 252 is a contact beam that projects at an angle with respect to the body section 256 toward the mating interface 253. For example, the contact finger 252 may form an angle that is between 60°-90° with respect to the body section 256. The contact finger 252 and a remainder of the electrical contact 250 are dimension to achieve a designated normal force against the conductive pathway 280. More specifically, the normal force is applied by the mating interface 253 to the conductive pathway 280 to make a sufficient electrical connection.

The mating terminal 254 is configured to mechanically and electrically engage another conductive element. In the illustrated embodiment, the mating terminal 254 is a compliant pin (e.g., eye-of-needle pin) that is configured to be inserted into a hole of another conductive element. For example, the mating terminal 254 may be deformed when the mating terminal 254 engages the plated thru-hole 116 (FIG. 1) of the circuit board 101.

FIG. 8 is an isolated perspective view of the electrical contact 260. As shown, the electrical contact 260 is identical to the electrical contact 250 and includes the contact finger 252 and the body section 256. The electrical contact 260, however, has a different mating terminal 264. In the illustrated embodiment, the mating terminal 264 is a shoe that is sized and shaped to engage a crimp body 268 during a crimping operation. The crimp body 268, in turn, is mechanically and electrically engaged to a wire 270. In FIG. 8, only fibers of the wire 270 are shown. The crimp body 268 represents a coupling end of a cable.

FIG. 9 is an isolated perspective view of the socket housing 108 having the electrical contacts 250 positioned within the respective contact channels 211-213. As described above, the electrical contacts 250 are inserted into the respective contact channels 211-213 through the underside 202 (FIG. 5). The body sections 256 (FIG. 7) may frictionally engage interior surfaces of the socket housing 108 that define the respective contact channel. The mating interfaces 253 extend into the seating space 170 defined by the socket housing 108.

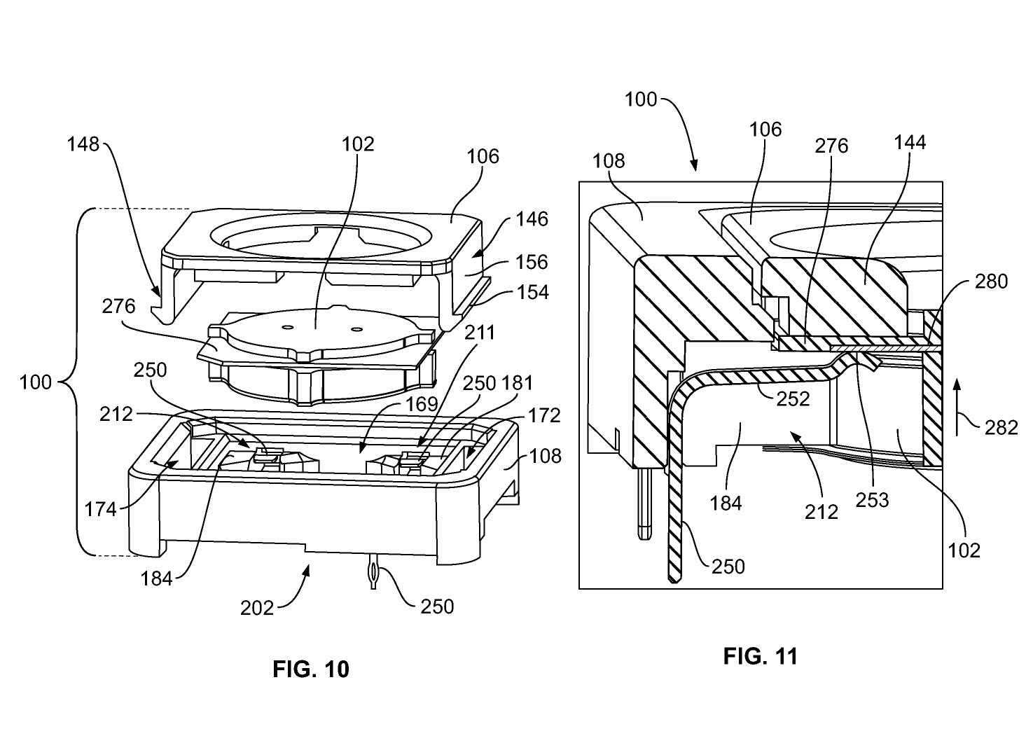

FIG. 10 is an exploded view of the sensor package 100 illustrating how the elements of the sensor package 100 may be stacked together. After the electrical contacts 250 are inserted into the respective contact channels 211, 212 and 213 (FIG. 5), the sensor module 102, led by the sensor side 125, may be inserted into and positioned within the socket cavity 169. As shown, the sensor module 102 includes a board substrate (or substrate layer) 276 that extends along a periphery of the sensor module 102. The board substrate 276 may extend through the sensor module 102 and generally separate a reservoir (not show) and a filter (not shown) of the sensor module 102. The reservoir may be positioned between the sensor side 125 and the board substrate 276, and the filter may be positioned between the sensor side 124 and the board substrate 276. The board substrate 276 is configured to engage the shoulders 181, 184 and 182, 183 (FIG. 4). As the board substrate 276 is moved toward the shoulders 181-184, the board substrate 276 may engage the electrical contacts 250 as described below. Although the above describes one particular design of the sensor module, it should be understood that other sensor modules having different designs may be used.

After the sensor module 102 is positioned within the socket cavity 169, the retaining cover 106 may be mounted onto the sensor module 102 and the socket housing 108. For example, the attachment structures 146, 148 may be inserted into the receiving slots 172, 174, respectively. More specifically, as the latches 156 are inserted into the corresponding receiving slots 172, 174, the latches 156 may be deflected from an undeflected condition to permit the latches 156 to be inserted therein. After the grips 154 clear the underside 202, the latches 156 may flex back toward an undeflected condition whereby the grips 154 may engage the underside 202.

FIG. 11 is an enlarged cross-section of a portion of the sensor package 100 when it is fully assembled. FIG. 11 is through the contact channel 212. When fully assembled, the sensor package 100 has an integrated structure that may be held and moved as a unit (e.g., for mounting to the circuit board or otherwise positioning at a desired location). As shown, the board substrate 276 is sandwiched between the cover section 144 of the retaining cover 106 and the shoulder 184 of the socket housing 108. In addition, the mating interface 253 of the electrical contact 250 is engaged with the conductive pathway 280. The conductive pathway 208 may be a conductive trace and is electrically coupled to an interior of the sensor module 102.

The contact finger 252 is in a deflected condition such that the electrical contact 250 exerts a normal force 282 against the conductive pathway 280. The retaining cover 106, however, prevents the contact finger 252 from moving the sensor module 102 away from its seated position in FIG. 11. The normal force 282 is configured to provide a sufficient electrical connection between the electrical contact 250 and the sensor module 102 during lifetime operation of the sensor package 100. Because the body section 256 is positioned within the contact channel 212 and secured by the socketing housing 108, the contact finger 252 is permitted to move (e.g., flex) while the body section 256 and the mating terminal 254 have a substantially fixed position with respect to the socket housing 108.

In FIG. 11, the sensor package 100 is fully assembled. In this configuration, the mating terminals 254 may be inserted into the plated thru-holes 116 (FIG. 1) of the circuit board 101 (FIG. 1). The socket housing 108 and the shape of the electrical contact 250 (e.g., the body section 256) may prevent the electrical contact 250 from being displaced during this mounting operation. Accordingly, the sensor package 100 may be manufactured without using conductive epoxies, adhesives, or putties to electrically connect different components. In some embodiments, the sensor package 100 is devoid of conductive epoxies, adhesives, or putties for electrically connecting the electrical contacts 250 to the sensor module 102. In other embodiments, the sensor package 100 may include at least some conductive epoxies, adhesives, or putties. However, embodiments may permit using a reduced amount of such material.

FIG. 12 is an isolated perspective view of a sensor package 300 formed in accordance with an embodiment. The sensor package 300 may be identical to the sensor package 100 (FIG. 1). For example, the sensor package 300 includes a sensor module 302, a retaining cover 306, and a socket housing 308. However, the sensor package 300 also includes a plug assembly 310 having a modular plug 312 and cables 314. The cables 314 are sized and shaped to be inserted into cable slots 316 along an underside 318 of the socket housing 308. Each of the cables 314 includes a coupling end that is configured to engage electrical contacts (not shown) of the sensor package 300. The electrical contacts may be identical to the electrical contacts 260 (FIG. 8). More specifically, the electrical contacts may include shoes, such as the shoes 264, that are configured to mechanically and electrically engage corresponding crimp bodies 268. In this example, the crimp bodies 268 are coupling ends of the cables 314. As such, the cables 314 may electrically connect the modular plug 312 and the sensor module 302. Such embodiments may be suitable for applications in which it is challenging to mount the sensor package to a circuit board.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The patentable scope should, therefore, be determined with reference to the appended claims, along with the full scope of equivalents to which such claims are entitled.

As used in the description, the phrase “in an exemplary embodiment” and the like means that the described embodiment is just one example. The phrase is not intended to limit the inventive subject matter to that embodiment. Other embodiments of the inventive subject matter may not include the recited feature or structure. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(f), unless and until such claim limitations expressly use the phrase “means for” followed by a statement of function void of further structure.

What is claimed is:

1. A sensor package comprising:
a package housing defining a receiving cavity and having a package side, the package side including a detector opening therethrough;
a sensor module held by the package housing and disposed within the receiving cavity, the sensor module having a sensor side that is aligned with the detector opening such that the sensor side is exposed to a detection space, the sensor module also including a conductive pathway that is configured to transmit signals that are based on an environmental parameter detected by the sensor module; and
an electrical contact coupled to the package housing, the electrical contact including a contact finger, the contact finger being engaged to the conductive pathway and exerting a normal force against the conductive pathway.

2. The sensor package of claim 1, wherein the package housing includes a socket housing and a retaining cover, the sensor module being positioned between the socket housing and the retaining cover.

3. The sensor package of claim 2, wherein the socket housing forms a seating space that is sized and shaped to receive the sensor module, the contact finger being positioned within or adjacent to the seating space, wherein the retaining cover holds the sensor module at a designated position as the contact finger presses against the conductive pathway of the sensor module.

4. The sensor package of claim 2, wherein the retaining cover includes a latch, the latch gripping the socket housing, the retaining cover holding the sensor module at a designated position as the contact finger presses against the conductive pathway of the sensor module.

5. The sensor package of claim 1, wherein the socket housing includes a shoulder that is configured to support the sensor module, the shoulder having a contact channel, the electrical contact being disposed in the contact channel.

6. The sensor package of claim 1, wherein the sensor module includes a board substrate that extends along a periphery of the sensor module, the conductive pathway being a conductive trace coupled to the board substrate.

7. The sensor package of claim 1, wherein the electrical contact includes a mating terminal that is configured to mechanically and electrically engage another conductive element.

8. The sensor package of claim 7, wherein the mating terminal includes a compliant pin that is sized and shaped to be inserted into a corresponding hole of a conductive element.

9. The sensor package of claim 7, further comprising a plug assembly having a modular plug and a cable that includes a coupling end, the coupling end being mechanically and electrically engaged to the mating terminal of the electrical contact, the cable electrically connecting the modular plug and the electrical contact.

10. The sensor package of claim 1, wherein the sensor module is an electrochemical sensor configured to detect one or more gases.

11. A sensor package comprising:
a package housing defining a receiving cavity and having a package side, the package side including a detector opening therethrough;
a sensor module held by the package housing and disposed within the receiving cavity, the sensor module having a sensor side that is aligned with the detector opening such that the sensor side is exposed to a detection space, the sensor module also including a conductive pathway that is configured to transmit signals that are based on an environmental parameter detected by the sensor module; and
an electrical contact coupled to the package housing, the electrical contact being electrically coupled to the conductive pathway of the sensor module, the electrical contact including a mating terminal that is configured to mechanically and electrically engage another conductive element.

12. The sensor package of claim 11, wherein the package housing includes a socket housing and a retaining cover, the sensor module being positioned between the socket housing and the retaining cover.

13. The sensor package of claim 12, wherein the retaining cover defines a shape of the detection space.

14. The sensor package of claim 12, wherein the retaining cover includes a latch that grips the socket housing, the retaining cover and the socket housing engaging opposite sides of the sensor module.

15. The sensor package of claim 11, wherein the socket housing includes a shoulder that is configured to support the sensor module, the shoulder having a contact channel, the electrical contact being disposed within the contact channel.

16. The sensor package of claim 11, wherein the sensor module includes a board substrate that extends along a periphery of the sensor module, the conductive pathway being a conductive trace coupled to the board substrate.

17. The sensor package of claim 11, wherein the electrical contact includes a contact finger that is configured to be deflected by the sensor module and exert a normal force against the conductive pathway.

18. The sensor package of claim 11, wherein the mating terminal includes a compliant pin that is sized and shaped to be inserted into a corresponding hole of a conductive element.

19. The sensor package of claim 11, further comprising a plug assembly having a modular plug and a cable that includes a coupling end, the coupling end being mechanically and electrically engaged to the mating terminal of the electrical contact, the cable electrically connecting the modular plug and the electrical contact.

20. The sensor package of claim 11, wherein the sensor module is an electrochemical sensor configured to detect one or more gases.
